(19) United States
(12) Patent Application Publication
(10) Pub. No.: US 2026/0288968 A1
(43) Pub. Date: Sep. 24, 2026

(54) Noise reduction

(71) Applicant: CARDINALOPS LTD., Tel Aviv (IL)

(72) Inventors: Yair Manor, Netanya (IL); Ilan Goldschmidt, Modiin (IL); Bar Grinshtein, Ashdod (IL); Amihai Hadar, Herzeliya (IL); Yair Rascovsky, Beer Sheva (IL)

(21) Appl. No.: 19/083,482

(22) Filed: Mar. 19, 2025

(51) Int. Cl. G06F 21/57

(52) U.S. Cl. CPC G06F 21/577

(57) ABSTRACT

In one embodiment, a method for improving protection of a computer system from malicious activity includes receiving a set of alerts generated by a rule of a security monitoring system over a specified time period, analyzing the alerts to identify groups of name-value pair combinations, the analyzing including searching for combinations of name-value pairs within the set of alerts, and calculating a measurement of alerts for each of the combinations, and presenting one or more what-if scenarios to a user, each scenario showing an impact of the identified groups of name-value pair combinations in the security monitoring system.

### FIELD OF THE DISCLOSURE

The present disclosure relates to computer systems, and in particular, but not exclusively, to computer security.

### BACKGROUND

Security systems such as Security Information and Event Management (SIEM) systems have become an essential component of modern cybersecurity infrastructure. These systems collect, analyze, and correlate log data and security events from various sources across an organization's network to detect and respond to potential security threats. SIEM systems typically employ a set of rules to identify suspicious activities or patterns that may indicate a security incident.

SIEM servers work by gathering all the event logs from configured devices. The logs are sent to a collector, which typically runs on a virtual machine inside the host network. The logs are securely sent from the collector to the SIEM. In other cases, the logs can be sent directly to the SIEM server, or the logs can be sent to a storage location (e.g., an S3 bucket), from which the SIEM server pulls them periodically.

SIEM servers use rules that help security teams define threats and generate alerts. Simple SIEM rules detect an event type and trigger a response, while composite rules nest or join two or more rules or statements to achieve a more complex behavior. Common SIEM correlation rules include brute force detection, impossible travel, excessive file copying, distributed denial-of-service (DDoS) attack, and file integrity change.

While SIEM systems are powerful tools for enhancing an organization's security posture, they often face challenges related to the generation of excessive alerts, particularly when rules are defined too broadly. This phenomenon, commonly referred to as alert fatigue or noise, can significantly impact the effectiveness of security operations.

Broad rules in SIEM systems may trigger a large number of alerts, including many false positives. False positives occur when the system flags benign activities as potential security threats. This overabundance of alerts can overwhelm security analysts, making it difficult to distinguish between genuine threats and harmless events.

### SUMMARY

There is provided in accordance with an embodiment of the present disclosure, a method for improving protection of a computer system from malicious activity, including receiving a set of alerts generated by a rule of a security monitoring system over a specified time period, analyzing the alerts to identify groups of name-value pair combinations, the analyzing including searching for combinations of name-value pairs within the set of alerts, and calculating a measurement of alerts for each of the combinations, and presenting one or more what-if scenarios to a user, each scenario showing an impact of the identified groups of name-value pair combinations in the security monitoring system.

Further, in accordance with an embodiment of the present disclosure each of the alerts includes an array of elements having corresponding field names and values, such that each field and associated value or part of the associated value defines a corresponding name-value pair.

Still further in accordance with an embodiment of the present disclosure the analyzing includes analyzing the alerts to identify potential exclusions of the rule, the calculating including calculating the measurement of alerts that would be excluded by each of the combinations, and the presenting includes presenting the one or more what-if scenarios to the user, each scenario showing the impact of applying a potential exclusion to the rule in the security monitoring system.

Additionally in accordance with an embodiment of the present disclosure the analyzing the alerts includes finding a given combination that returns the measurement of the alerts below a first threshold measurement, and omitting from the searching any other ones of the combinations that include the given combination.

Moreover, in accordance with an embodiment of the present disclosure the searching for the combinations includes starting with combinations of two name-value pairs, and progressively increasing the number of the name-value pairs in the combinations.

Further in accordance with an embodiment of the present disclosure the combinations considered for the searching are defined by a tree structure having a root, branches and nodes, the combinations associated with the nodes further away from the root of the tree structure include a corresponding increasing number of the name-value pairs, for a given one of the nodes, the combination of the name-value pairs of the given node is included in the combinations of all sub-nodes of the given node, and the method further includes, in response to the searching for the given combination of the name-value pairs in the alerts returning the measurement of the alerts below the first threshold, pruning a part of the tree to remove all of the branches below a corresponding one of the nodes so that combinations of the name-value pairs associated with the pruned part of the tree are omitted from the searching for the combinations.

Still further in accordance with an embodiment of the present disclosure the searching for the combinations of the name-value pairs includes iteratively increasing the number of the name-value pairs in the combinations until a stopping condition is met.

Additionally in accordance with an embodiment of the present disclosure, the method includes, prior to the searching for the combinations of the name-value pairs removing the name-value pairs present in less than a second threshold measurement of the alerts or equal to 100% of the alerts, merging the name-value pairs that always appear together in the alerts into a merged name-value pair, and removing one or more generic or derived name-value pairs, wherein the removed name-value pairs are not used in the searching for the combinations, and the merged name-value pair is used in the searching for the combinations.

Moreover in accordance with an embodiment of the present disclosure, the method includes, prior to the searching for the combinations of the name-value pairs removing the name-value pairs present in less than a second threshold measurement of the alerts or equal to 100% of the alerts, wherein the removed name-value pairs are not used in the searching for the combinations, and adding back to at least one of the combinations of the name-value pairs, the previously removed name-value pairs equal to 100% of the alerts.

Further in accordance with an embodiment of the present disclosure, the method includes, prior to the searching for the combinations of the name-value pairs, removing one or more generic or derived name-value pairs, wherein the removed one or more generic or derived name-value pairs are not used in the searching for the combinations.

Still further in accordance with an embodiment of the present disclosure, the method includes, prior to the searching for the combinations of the name-value pairs, merging the name-value pairs that always appear together in the alerts into a merged name-value pair, wherein the merged field name-value pair is used in the searching for the combinations.

Additionally in accordance with an embodiment of the present disclosure, the method includes applying a selected exclusion to update the rule or replace the rule based on user input of one of the what-if scenarios.

Moreover, in accordance with an embodiment of the present disclosure, the method includes downloading the set of alerts via an application programming interface (API) of the security monitoring system.

Further in accordance with an embodiment of the present disclosure the presenting the one or more what-if scenarios includes displaying the combinations having the measurement of the alerts greater than a given threshold measurement, and sorting the displayed combinations by the measurement of the alerts for the respective combinations.

Still further in accordance with an embodiment of the present disclosure the measurement of alerts is a percentage of alerts.

There is also provided in accordance with another embodiment of the present disclosure, a system for improving protection of a computer system from malicious activity, including a processor configured to receive a set of alerts generated by a rule of a security monitoring system over a specified time period, analyze the alerts to identify groups of name-value pair combinations, search for combinations of name-value pairs within the set of alerts, calculate a measurement of alerts for each of the combinations, and present one or more what-if scenarios to a user, each scenario showing an impact of the identified groups of name-value pair combinations in the security monitoring system, and a memory to store data used by the processor.

Additionally in accordance with an embodiment of the present disclosure the processor is configured to analyze the alerts to identify potential exclusions of the rule, and calculate the measurement of alerts that would be excluded by each of the combinations, wherein each what-if scenario shows the impact of applying a potential exclusion to the rule in the security monitoring system.

Moreover, in accordance with an embodiment of the present disclosure the processor is configured to find a given combination that returns the measurement of the alerts below a first threshold measurement, and omit from searching any other ones of the combinations that include the given combination.

Further in accordance with an embodiment of the present disclosure the processor is configured to start searching for the combinations with the combinations of two name-value pairs, and progressively increase the number of the name-value pairs in the combinations used in the searching.

Still further in accordance with an embodiment of the present disclosure the combinations considered for the searching are defined by a tree structure having a root, branches and nodes, the combinations associated with the nodes further away from the root of the tree structure include a corresponding increasing number of the name-value pairs, for a given one of the nodes, the combination of the name-value pairs of the given node is included in the combinations of all sub-nodes of the given node, and the processor is configured, in response to the searching for the given combination of the name-value pairs in the alerts returning the measurement of the alerts below the first threshold, to prune a part of the tree to remove all of the branches below a corresponding one of the nodes so that combinations of the name-value pairs associated with the pruned part of the tree are omitted from the searching for the combinations.

Additionally in accordance with an embodiment of the present disclosure the processor is configured, prior to the searching for the combinations of the field values of the different fields, to remove the name-value pairs present in less than a second threshold measurement of the alerts or equal to 100% of the alerts, merge the name-value pairs that always appear together in the alerts, and remove one or more generic or derived name-value pairs, wherein the removed name-value pairs are not used in the searching for the combinations, and the merged name-value pairs are used in the searching for the combinations as a merged name-value pair.

Moreover, in accordance with an embodiment of the present disclosure the processor is configured to apply a selected exclusion to update the rule or replace the rule based on user input of one of the what-if scenarios.

There is also provided in accordance with still another embodiment of the present disclosure, a non-transitory computer-readable storage medium storing instructions that, when executed by a processor, cause the processor to receive a set of alerts generated by a rule of a security monitoring system over a specified time period, analyze the alerts to identify groups of name-value pair combinations search for combinations of name-value pairs within the set of alerts, and calculate a measurement of alerts for each of the combinations, and present one or more what-if scenarios to a user, each scenario showing an impact of the identified groups of name-value pair combinations in the security monitoring system.

### BRIEF DESCRIPTION OF THE DRAWINGS

The present disclosure will be understood from the following detailed description, taken in conjunction with the drawings in which:

FIG. 1 is a block diagram view of a security system constructed and operative in accordance with an embodiment of the present disclosure;

FIG. 2 is a flowchart including steps in a method of operation of the system of FIG. 1;

FIG. 3 is a tree structure for use in the method of FIG. 2; and

FIG. 4 is a flowchart including steps in a searching sub-method of the method of FIG. 2.

### DESCRIPTION OF EXAMPLE EMBODIMENTS

### Overview

The problem of noisy alerts is compounded by the complexity of modern IT environments. With numerous devices, applications, and users generating a constant stream of log data, SIEM systems must process and analyze vast amounts of information. Each alert may contain multiple fields with various possible values, further increasing the challenge of identifying truly malicious activities among the noise.

Furthermore, legitimate activities within an organization can often resemble potentially suspicious behavior, making it challenging to create rules that accurately differentiate between normal operations and actual security threats. This similarity between benign and malicious activities contributes to the difficulty in fine-tuning SIEM rules to reduce false positives without compromising the system's ability to detect real threats.

The high volume of alerts generated by broad rules not only strains the resources of security teams but also potentially masks genuine security incidents. Analysts may become desensitized to alerts or struggle to prioritize their investigations effectively, potentially leading to delayed responses to critical threats or missed detections altogether.

Addressing the challenge of noise in SIEM systems requires a delicate balance between maintaining comprehensive threat detection capabilities and minimizing false positives. Improved methods for analyzing alert patterns, identifying common characteristics of false positives, and refining rule sets are needed to enhance the efficiency and effectiveness of SIEM (or other security) systems in protecting organizations against evolving cyber threats.

Embodiments of the present disclosure at least partially address the challenges presented by security monitoring systems such as Security Information and Event Management (SIEM) systems, particularly the issue of alert fatigue and noise caused by overly broad rules. Embodiments of the present disclosure aim to improve the efficiency and effectiveness of SIEM systems and/or provide useful feedback to system administrators, by analyzing alert patterns to identify significant groups of name-value pair combinations included in the alerts generated by a given rule, and present what-if scenarios to a user showing the impact of identified groups of name-value pair combinations included in the alerts generated by the given rule. The what-if scenarios may provide insight into security events and/or may be used to provide new rules or exclusions to an existing rule to reduce false positives while maintaining comprehensive threat detection capabilities.

An “alert” as used in the specification and claims is defined to include a notification produced in response to a security monitoring system checking for events that trigger a rule. The alert may include all the available fields to describe the triggered event or a subset of the available fields to describe the triggered event. The subset of the available fields may be defined by an alert creator or by any suitable user. In some systems, the “alert” may include less than all the available fields, but more than the fields selected by the alert creator.

Each alert includes values of different fields. By way of a simple example, seven alerts are shown below in the table and include an IP field, a Hostname field, and a Process field.

| Alert Number | Field = IP | Field = Hostname | Field = Process |
|---|---|---|---|
| 0 | 1.1.1.1 | HostA.acme.com | notepad.exe |
| 1 | 1.1.1.1 | HostA.acme.com | calc.exe |
| 2 | 1.1.1.1 | HostA.acme.com | winword.exe |
| 3 | 1.1.1.1 | HostA.acme.com | excel.exe |
| 4 | 2.2.2.2 | HostB.acme.com | powerpnt.exe |
| 5 | 2.2.2.2 | HostB.acme.com | cmd.exe |
| 6 | 2.2.2.2 | HostB.acme.com | Powershell.exe |

The alerts in the table show that values for the IP field may be 1.1.1.1 or 2.2.2.2, and the values of the Process field may include notepad.exe or calc.exe, and so on. Therefore, each alert includes different name-value pairs of field names and respective field values (of the fields), for example, IP=1.1.1.1 is a name-value pair, IP=2.2.2.2 is a name-value pair, and Hostname=HostA.acme.com is another name-value pair.

In some embodiments, the system includes receiving a set of alerts generated by a given rule (of the SIEM or other security monitoring system) over a specified time period. These alerts are then analyzed by examining combinations of name-value pairs appearing within the alerts to identify significant groups of name-value pair combinations (e.g., potential exclusions to the rule). For example, the system may analyze the alerts to find alerts including the name-value pairs of IP=1.1.1.1 and process=cmd.exe. The system analyzes combinations of different name-value pairs and different numbers of name-value pairs, for example, combinations of two name-value pairs, combinations of three name-value pairs, and so on.

The system calculates a measurement (e.g., a count or percentage) of alerts including each combination of name-value pairs (e.g., the number or percentage of alerts that would be excluded by each identified potential exclusion), providing insight into security events and/or the impact of applying these exclusions to the rule. For example, the system may calculate the percentage of alerts including the combination of name-value pairs “IP=1.1.1.1 and process=cmd.exe”, and the combination of name-value pairs “IP=2.2.2.2 and process=calc.exe and action=file deletion”. By way of example, let us assume that the combination of name-value pairs “IP=1.1.1.1 and process=cmd.exe” is found in 46% of the alerts for the rule, and the combination of name-value pairs “IP=2.2.2.2 and process=calc.exe and action=file deletion” is found in 5% of the alerts of the rule. If 30% is defined as a significant group for a combination, then the combination of name-value pairs “IP=1.1.1.1 and process=cmd.exe” will be defined as a significant group and be listed among the what-if scenarios presented to the user, whereas the combination of name-value pairs “IP=2.2.2.2 and process=calc.exe and action=file deletion” will not be defined as a significant group, and may not be listed among the what-if scenarios presented to the user.

To present this information to users, the system generates what-if scenarios. In some cases, each scenario demonstrates the potential impact of applying a specific exclusion and/or the impact of a group for a given rule. This approach allows security analysts to make informed decisions about refining (SIEM or other security monitoring system) rules based on concrete data. Based on the above example, a what if scenario could be “the combination of name-value pairs “IP=1.1.1.1 and process=cmd.exe” is found in 46% of the alerts for the rule, if the combination of name-value pairs “IP=1.1.1.1 and process-cmd.exe” is excluded from the rule then the number of alerts generated by the rule will be reduced by 46%”.

In order to identify the significant groups, all the combinations of name-values pairs found in the alerts should theoretically be analyzed to identify which combinations represent the significant groups among the alerts for a given rule. As an alert may have many fields, for example 20 to 100 or more fields, and those fields can have many different values, and a rule may generate many alerts, the computational task to find the different combinations of the name-value pairs in the alerts may take hours, days, weeks, or even longer to complete.

Therefore, embodiments of the present disclosure provide an analysis process which is efficient and thorough. It begins by examining combinations of two name-value pairs and progressively increases the number of name-value pairs in the combinations. If a combination of two name-value pairs is included in fewer alerts than the threshold (e.g., 30%), all combinations that include these two name-value pairs plus any one or more other name-value pairs are automatically excluded from further analysis. Similarly, if a combination of three name-value pairs is included in fewer alerts than the threshold (e.g., 30%), all combinations that include these three name-value pairs plus any one or more other name-value pairs are automatically excluded from further analysis, and so on. In this manner, wasted analysis is avoided and computation time is significantly reduced. This systematic approach allows for a comprehensive exploration of potential exclusions while managing computational complexity.

To further optimize the analysis, the method incorporates one or more pre-processing steps. These may include removing name-value pairs that are present in less than a threshold percentage (e.g., 30%) of alerts or present in all alerts, merging name-value pairs that always appear together and searching using the merged name-value pair, and/or removing generic or derived field values, as described in disclosed embodiments. These steps help focus the analysis on the most relevant data to reduce the number of name-value pairs to be used in the search, and therefore reduce the number of combinations that are searched.

Some embodiments employ an efficient tree structure to organize and analyze the combinations of name-value pairs for searching within the alerts. This tree structure starts with a root for each name-value pair, and each level of the tree corresponds to an increasing number of combinations of name-value pairs based on the combinations above it.

The tree is constructed and traversed in a way that allows for systematic exploration of name-value pair combinations as described in disclosed embodiments. It begins with combinations of two name-value pairs at the first level, then progresses to combinations of three name-value pairs, and so on. This approach enables a thorough examination of potential combinations while managing the computational complexity of the analysis.

A key feature of this tree structure is its pruning mechanism, which significantly enhances the efficiency of the analysis process. When a specific combination of name-value pairs at a node returns a measurement of alerts below a predefined threshold (e.g., below 30% of the total alerts), the entire branch (or branches) below that node is pruned. This pruning occurs because any combination that includes the name-value pairs of the pruned node would necessarily return a measurement of an even smaller subset of alerts, making it unnecessary to analyze these combinations further. This pruning mechanism substantially reduces the number of combinations that need to be evaluated, thereby improving the overall performance of the analysis. The tree structure also allows for efficient tracking of the relationships between different name-value pair combinations.

By leveraging this tree structure with its pruning capability, embodiments of the disclosure can efficiently process large volumes of alert data, identify significant groups, and provide meaningful insights to security analysts. This approach addresses the challenges of alert fatigue and noise in SIEM (and other security) systems by offering a systematic and computationally efficient method for refining alert rules and reducing false positives.

Importantly, the system allows for user interaction and feedback. After presenting the what-if scenarios, users can select and apply exclusions to update the rule(s) based on their expert judgment and the insights provided by the analysis.

By providing a systematic and data-driven approach to refining SIEM (or other security system) rules, embodiments of the disclosure address the critical challenge of balancing comprehensive threat detection with the need to minimize false positives and reduce alert fatigue. It empowers security teams to make informed decisions about rule refinement, ultimately enhancing the overall effectiveness of SIEM (or other security) systems in protecting organizations against evolving cyber threats.

### System Description

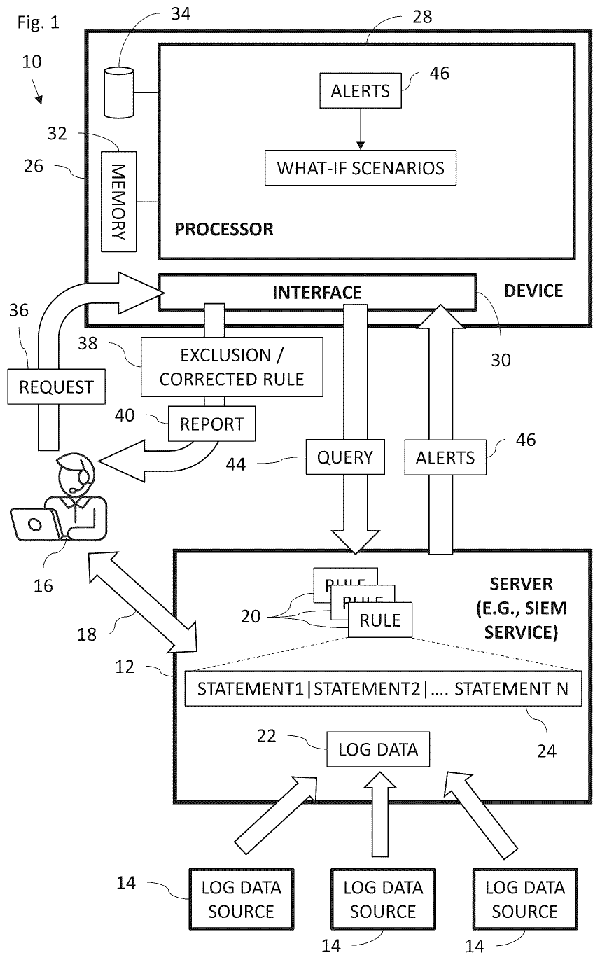

Reference is now made to FIG. 1, which is a block diagram view of a security system 10 constructed and operative in accordance with an embodiment of the present disclosure. The system 10 includes a server 12 (or security monitoring system) such as a security information and event management (SIEM) server or SIEM service or any suitable server or data service, or rule-based detection service which tracks events and reports on those events using rules (e.g., SIEM correlation rules or security rules), or a rule-based security service. The server 12 is configured to receive log data 22 from different log data sources 14 or from one or more collectors (not shown) which collect log data from the log data sources 14.

A system administrator 16 interacts (arrow 18) with the server 12 and configures rules 20 that should be run by the server 12 against the log data 22, for example, when the log data 22 is received from the log data sources 14. The server 12 may also generate an alert to the system administrator 16 when one of the rules provides a positive match with one or more events in the log data 22. Each rule 20 includes a respective number of statements 24 which define what the rule is checking for. The statements 24 may be ordered in any suitable manner. However, in many cases, the statements 24 are structured to start with the broadest statement and then progress to narrower statements so that the final statement is generally viewed as being the narrowest statement. The statements may be separated by any suitable symbol(s), for example, using a pipe symbol “|”. The server 12 may provide Application Programming Interfaces (APIs) to allow other entities (e.g., the system administrator 16 and a data service checking device 26) to interact with the server 12.

The system 10 also includes data service checking device 26, which includes a processor 28, interface 30, memory 32, and a database 34. The device 26 may receive requests 36 from the system administrator 16 to check one or more of the rules 20 to determine if the rule(s) is (are) are generating too much noise. The device 26 may be configured to automatically check one or more of the rules 20 periodically.

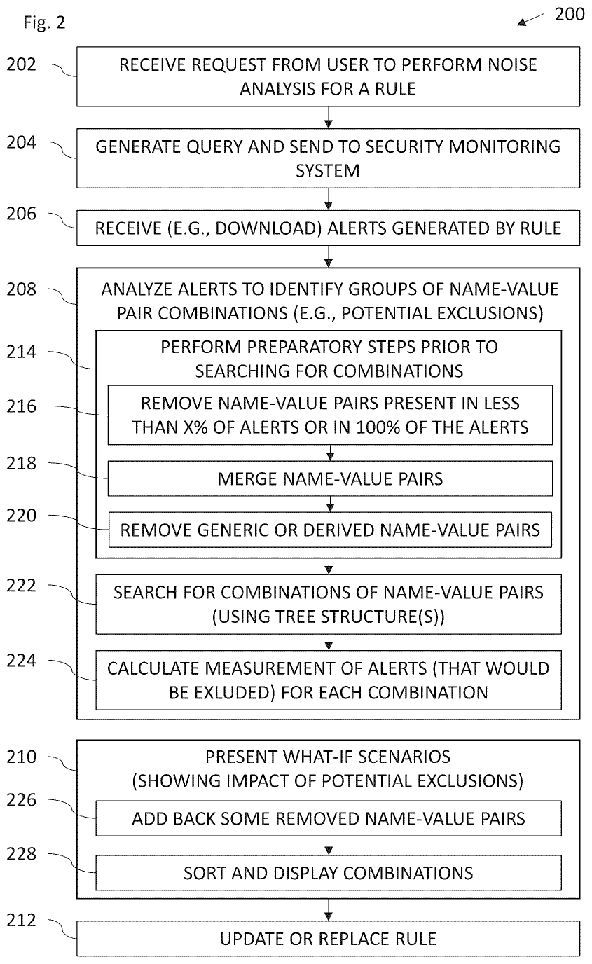

The interface 30 (which may include a network interface and/or a communication data bus interface) is configured to receive the requests 36 from the system administrator 16 and provide data (such as a rule exclusion or a corrected rule 38 (described in more detail below with reference to FIGS. 2-4) and reports 40) to the system administrator 16. The interface 30 may also be configured to receive rules 20 and other data from the server 12 as well as provide queries 44 to the server 12, described in more detail below. The memory 32 is configured to store data used by the processor 28. The database 34 may be configured to store data such as retrieved alerts and name-value pairs and report data, described in more detail below.

The processor 28 is configured to generate queries 44 to request data from the server 12 such alert data 46 of the requested rule(s) 20. The server 12 is configured to provide the alert data 46 to the processor 28, as requested. The processor 28 analyzes the alert data 46 to determine significant groups of name-value pair combinations in the alert data 46 and present what-if scenarios to the system administrator 16 in the report 40. The processor 28 may perform an action such as correcting a rule in the server 12 or providing an exclusion to a rule to the system administrator 16, as described in more detail with reference to FIGS. 2-4.

In some embodiments, the functionality of the device 26 is executed by a cloud-based server. In some embodiments, the functionality of the server 12 is executed by a cloud-based server. In some embodiments, the functionality of the server 12 and the device 26 may be executed by the same device or server and/or the same processor.

In practice, some or all of the functions of the processor 28 may be combined in a single physical component or, alternatively, implemented using multiple physical components. These physical components may comprise hard-wired or programmable devices, or a combination of the two. In some embodiments, at least some of the functions of the processor 28 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2, which is a flowchart 200 including steps in a method of operation of the system 10 of FIG. 1. The method may improve protection of a computer system from malicious activity.

In some embodiments, the processor 28 is configured to receive request 36 from system administrator 16 to perform noise analysis for a given rule 20 (or rules) (block 202). The processor 28 is configured to generate query 44 to receive a set of alerts 46 generated by the given rule of the server 12 (e.g., security monitoring system) over a specified time period (block 204). The query 44 is sent to server 12. The processor 28 is configured to receive the set of alerts 46 generated by the given rule of the security monitoring system over the specified time period (block 206). Each of the alerts 46 includes an array of elements having corresponding field names and values. Each field name and its associated value (or part of the value) defines a corresponding name-value pair. In some embodiments, the alerts are sent by the server 12 to a ticketing system or to an orchestration system. In those cases, the processor 28 may be configured to retrieve the alerts from the ticketing/orchestration system rather than from the server 12.

By way of a simple example, seven alerts are shown below in the table and include an IP field, a Hostname field, and a Process field.

| Alert Number | Field = IP | Field = Hostname | Field = Process |
|---|---|---|---|
| 0 | 1.1.1.1 | HostA.acme.com | notepad.exe |
| 1 | 1.1.1.1 | HostA.acme.com | calc.exe |
| 2 | 1.1.1.1 | HostA.acme.com | winword.exe |
| 3 | 1.1.1.1 | HostA.acme.com | excel.exe |
| 4 | 2.2.2.2 | HostB.acme.com | powerpnt.exe |
| 5 | 2.2.2.2 | HostB.acme.com | cmd.exe |
| 6 | 2.2.2.2 | HostB.acme.com | Powershell.exe |

The alerts in the table show that values for the IP field may be 1.1.1.1 or 2.2.2.2, and the values of the Process field may include notepad.exe or calc.exe, and so on. Therefore, each alert includes different name-value pairs of field names and corresponding field values, for example, IP=1.1.1.1 is a name-value pair, IP=2.2.2.2 is a name-value pair, and Hostname=HostA.acme.com is another name-value pair.

In some embodiments, the processor 28 may be configured to download the set of alerts 46 via an application programming interface (API) of the security monitoring system 12.

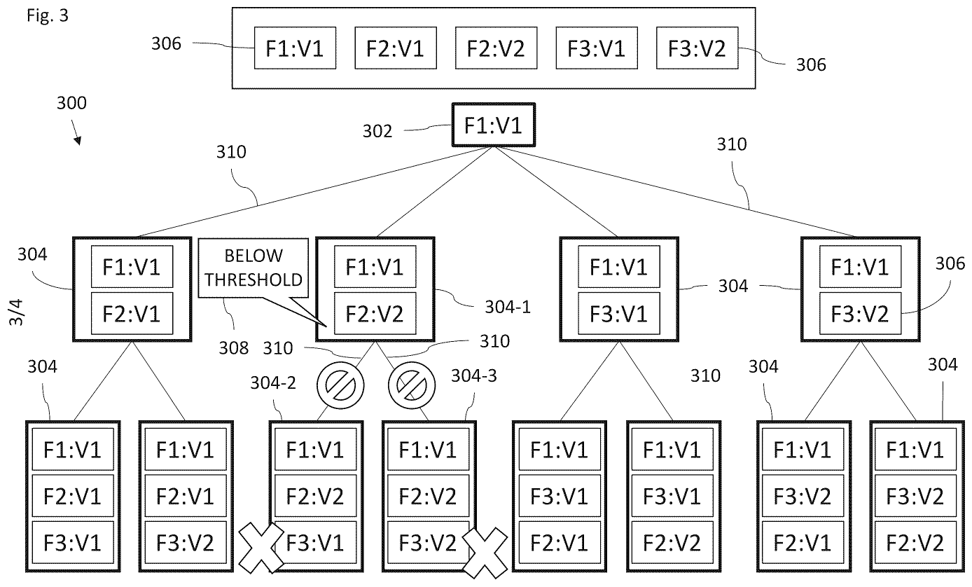

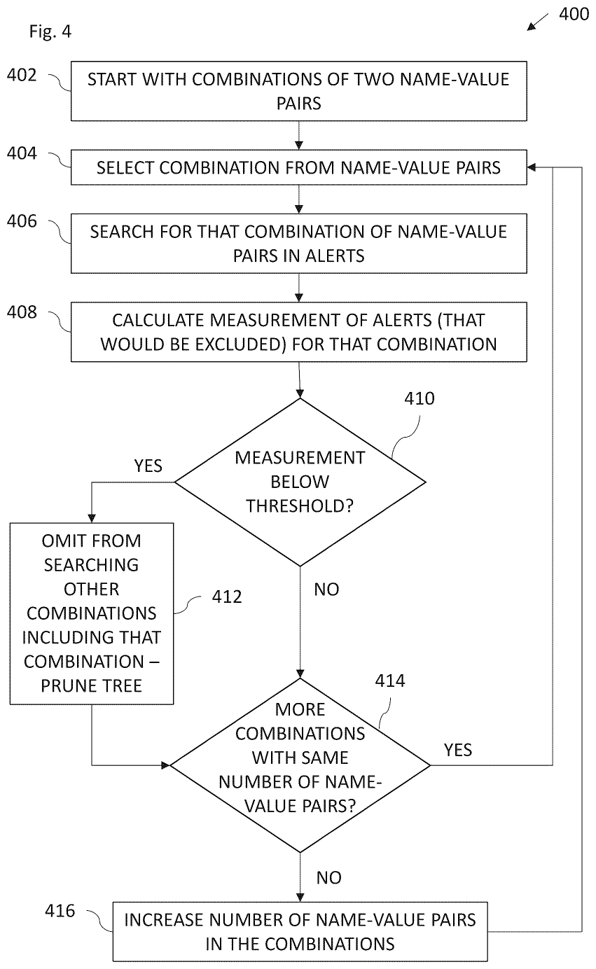

The processor 28 is configured to analyze the alerts 46 to identify groups of name-value pair combinations (block 208). In some embodiments, the processor 28 is configured to analyze the alerts 46 to identify potential exclusions of the given rule 20. The analysis of the alert data 46 is described in more detail with reference to the steps of blocks 216-224 below and with reference to FIGS. 3 and 4.

The processor 28 is configured to present one or more what-if scenarios to the system administrator 16 (block 210). Each what-if scenario may show the impact (e.g., noise in the system or exclusions to the rule) of the identified groups of name-value pair combinations in the security monitoring system 12. In some embodiments, the processor 28 is configured to present the what-if scenario(s) to the system administrator 16 with each scenario showing the impact of applying a potential exclusion to the given rule 20 in the security monitoring system 12. The step of block 210 is described in more detail with reference to the steps of blocks 226 and 228 below.

The analysis performed by the processor 28 may be used by system administrator 16 to find interesting events highlighted by the significant groups, to refine the rule by changing the rule to exclude name-value pair combinations associated with one or more of the significant groups, and/or to remove the alerts 46 associated with the significant groups from the alert data 46 to leave remaining alert data for analysis purposes by system administrator 16. The analysis performed by system administrator 16 may lead to the rule being amended, e.g., using an exclusion, or may lead to a change in internal procedures or permissions for operations. For example, if a significant group of alerts indicates that internal procedures are not being followed or need to be changed, the system administrator 16 may change permissions and/or internal procedures.

In some embodiments, the processor 28 is configured to apply a selected exclusion to update the rule or replace the rule based on user input of one of the what-if scenarios (block 212). The processor 28 may be configured to directly update the rule in server 12, e.g., via an API, and/or display the script of the exclusion or new rule for copying by the system administrator 16 or for sharing via any suitable communication method.

The analyzing step of block 208 also includes searching for combinations of name-value pairs as described in more detail with reference to the step of block 222, and calculating measurements of the alerts found for each combination as described in more detail with reference to the step of block 224. In some embodiments, prior to performing the step of searching for the combinations of the name-value pairs, the processor 28 is configured to perform preparatory steps (block 214) described in more detail with reference to the steps of block 216-220 which aim to reduce the number of name-value pairs used in the searching step of block 222, e.g., some name-value pairs may be removed or merged, as described in more detail below with reference to the steps of blocks 216-220.

In some embodiments, the processor 28 is configured to remove name-value pairs present in less than a given threshold measurement (e.g., 30%) of the alerts 46 or equal to 100% of the alerts 46 (block 216). The removed name-value pairs are not used in searching for the combinations. For example, if the name-value pair “IP=1.1.1.1” is included in less than 30% of the alerts, that name-value pair is not used in searching for the combinations. For example, if the name-value pair “Domain=A” is included in 100% of the alerts, that name-value pair is not used in searching for the combinations.

In some embodiments, the processor 28 is configured to merge name-value pairs that always appear together in the alerts 46 into a merged name-value pair (block 218). The merged field name-value pair is used in searching for the combinations.

Merging name-value pairs is now explained by way of a simple example. Seven alerts are shown below in the table and include an IP field, a Hostname field, and a Process field.

| Alert Number | Field = IP | Field = Hostname | Field = Process |
|---|---|---|---|
| 0 | 1.1.1.1 | HostA.acme.com | notepad.exe |
| 1 | 1.1.1.1 | HostA.acme.com | calc.exe |
| 2 | 1.1.1.1 | HostA.acme.com | winword.exe |
| 3 | 1.1.1.1 | HostA.acme.com | excel.exe |
| 4 | 2.2.2.2 | HostB.acme.com | powerpnt.exe |
| 5 | 2.2.2.2 | HostB.acme.com | cmd.exe |
| 6 | 2.2.2.2 | HostB.acme.com | Powershell.exe |

Naively, the processor 28 should check all combinations of the following name-value pairs:
1. IP: 1.1.1.1
2. IP: 2.2.2.2
3. Hostname: HostA.acme.com
4. Hostname: HostB.acme.com
5. Process: notepad.exe
6. Process: calc.exe
7. Process: winword.exe
8. Process: excel.exe
9. Process: powerpnt.exe
10. Process: cmd.exe
11. Process: powershell.exe

This, in principle, requires checking around 211 or 2047 combinations.

However, it can be seen that all alerts including IP equal to 1.1.1.1 also include Hostname equal to HostA.acme.com, so there is no need to search for a combination that has IP 1.1.1.1 but a Hostname that is not HostA.acme.com as they always appear together in the alerts for the given rule. Similarly, all alerts including IP equal to 2.2.2.2 also include Hostname equal to HostB.acme.com. We can thus effectively merge these name-value pairs, giving a reduced number of name-value pairs for use in searching, as follows:
1. IP: 1.1.1.1 and Hostname: HostA.acme.com
2. IP: 2.2.2.2 and Hostname: HostB.acme.com
3. Process: notepad.exe
4. Process: calc.exe
5. Process: winword.exe
6. Process: excel.exe
7. Process: powerpnt.exe
8. Process: cmd.exe
9. Process: powershell.exe

This leaves only 9 (effective) name-value pairs, so the total number of combinations to be searched has been reduced by 75% to 29 or 512 combinations.

In some embodiments, the processor 28 is configured to remove one or more generic or derived name-value pairs (block 220). The removed generic or derived name-value pairs are not used in searching for the combinations. For example, some fields are generic and carry little information. Some name-value pairs may be derived from other name-value pairs, for example, a customer can enrich an event that contains an IP with the criticality of this IP. For noise analysis purposes the generic fields and derived name-value pairs are usually redundant and just add unneeded combinations to the searching stage.

As previously mentioned, the analyzing step of block 208 also includes searching for combinations of name-value pairs and calculating measurements of the alerts found for each combination. The processor 28 is configured to search for combinations of name-value pairs within the set of alerts 46 (block 222). The name-value pairs may include the whole value of the value of a field. One or more name-value pairs may include part of the value of a field. For example, a field value may include a folder name and file name, while the name-value pair used in searching may include the folder name without the file name. This may be achieved by using regular expressions as part of the search process, e.g., find a value of a given field which “contains” value X.

The processor 28 is configured to calculate a measurement (a count, percentage or fraction) of alerts 46 for each of the combinations (block 224). In some embodiments, the processor 28 is configured to calculate the measurement of alerts that would be excluded by each of the combinations. For example, the processor 28 may calculate the percentage of alerts including the combination of name-value pairs “IP=1.1.1.1 and process=cmd.exe”, and the combination of name-value pairs “IP-2.2.2.2 and process=calc.exe and action=file deletion”. By way of example, let us say that the combination of name-value pairs “IP=1.1.1.1 and process=cmd.exe” is found in 46% of the alerts for the rule, and the combination of name-value pairs “IP=2.2.2.2 and process=calc.exe and action=file deletion” is found in 5% of the alerts of the rule. If 30% is defined as a significant group for a combination, then the combination of name-value pairs “IP=1.1.1.1 and process-cmd.exe” will be defined as a significant group and be listed among the what-if scenarios presented to the system administrator 16, whereas the combination of name-value pairs “IP-2.2.2.2 and process=calc.exe and action=file deletion” will not be defined as a significant group, and will not necessarily be listed among the what-if scenarios presented to the system administrator 16.

The step of block 210 is now described in more detail with reference to the steps of blocks 226-228. In some embodiments, the processor 28 is configured to add back to the combinations of the name-value pairs, the previously removed name-value pairs included in 100% of the alerts (and optionally the generic and derived name-value pairs), so that when the what-if scenarios are presented to the system administrator 16, the significant groups of name-value pairs include the complete picture of the name-value pairs. The processor 28 is configured to display the combinations having a measurement (e.g., count, percentage or fraction) of the alerts greater than a given threshold measurement (e.g., 30%), and sort the displayed combinations by the measurement of the alerts (e.g., in order of low to high or vice-versa) for the respective combinations. In some embodiments, there may be multiple combinations of name-value pairs where one is contained within the other, but the number of alerts does not change much between them. For example:
(a) the combination of (field name 1, value 1) and (field name 2, value 2) are included in 50% of the alerts; and
(b) the combination of (field name 1, value 1), (field name 2, value 2), (field name 3, value 3) are included in 49% of the alerts.

In this case, the processor 28 may display the second option, because it uses a more restrictive exclusion (creating a smaller gap in security), while eliminating virtually the same amount of noise.

In some cases, each what-if scenario demonstrates the potential impact of applying a specific exclusion. This approach allows security analysts to make informed decisions about refining (SIEM or other security monitoring system) rules based on concrete data. Based on the above example, a what-if scenario may include the following: “the combination of name-value pairs “IP=1.1.1.1 and process-cmd.exe” is found in 46% of the alerts for the rule, if the combination of name-value pairs “IP=1.1.1.1 and process=cmd.exe” is excluded from the rule then the number of alerts generated by the rule will be reduced by 46%”.

Reference is now made to FIG. 3, which is a tree structure 300 for use in the method of FIG. 2. Some embodiments employ an efficient tree structure 300 for each name-value pair to organize and analyze the combinations of name-value pairs for searching within the alerts 46. To illustrate the tree structure 300, five name-value pairs 306 are used, namely, F1:V1 (i.e., field 1 and value 1), F2:V1 (i.e., field 2 and value 1), F2:V2, F3:V1, and F3:V2. For the sake of simplicity, not all name-value pairs 306 are labeled in FIG. 3.

The tree structure 300 starts with a root 302 for a name-value pair, namely, F1:V1, in the example of FIG. 3. The tree structure 300 may be repeated with each of the name-value pairs listed above placed in root 302 and the tree structure 300 constructed accordingly.

Each level moving away from root 302 of the tree 300 corresponds to an increasing number of combinations of name-value pairs based on the combinations above it, as described in more detail below.

The tree structure 300 includes nodes 304 connected by branches 310. For the sake of simplicity, not all nodes 304 and branches 310 are labeled in FIG. 3. The tree structure 300 of FIG. 3 includes three levels, for the sake of simplicity, including the level of root 302. In general, the tree structure 300 may include any suitable number of levels depending on the number of name-value pairs. In the first level below the root 302, the name-value pair 306 included in root 302 is combined with each of the other name-value pairs 306 individually, e.g., F1:V1 with F2:V1 in one node, F1:V1 with F2:V2 in another node, and so on. In the second level below the first level, each combination of the first level is individually combined with each of the other name-value pairs 306. For example, the combination of F1:V1 with F2:V2 is further combined individually with F3:V1 and F3:V2. In subsequent levels, the construction is repeated. In this manner all the different logical combinations of name-value pairs 306 appear in tree structure 300. In some embodiments, some combinations such as F2:V1 with F2:V2 or F3:V1 with F3:V2 are not considered based on the same field with two different values not occurring in a single alert as each field generally has a unique value. However, for the sake of a streamlined process such combinations may also be considered and simply yield a null result. In other embodiments, combinations such as F2:V1 with F2:V2 or F3:V1 with F3:V2 are considered as in some cases an alert may return multiple values for the same field.

The tree 300 is constructed and traversed in a way that allows for systematic exploration of name-value pair combinations. It begins with combinations of two name-value pairs 306 at the first level, then progresses to combinations of three name-value pairs 306, and so on. This approach enables a thorough examination of potential combinations while managing the computational complexity of the analysis.

A key feature of this tree structure is its pruning mechanism, which significantly enhances the efficiency of the analysis process. When a specific combination of name-value pairs at a node returns a measurement of alerts below a predefined threshold (e.g., below 30% of the total alerts), the entire branch (or branches, e.g., branch structure) below that node is pruned. In the example of FIG. 3, the search for the combination of name-value pairs F2:V1 and F2:V2 yields a measurement below the threshold (e.g., below 30%) (block 308), therefore branches 310 below the node 304-1 are pruned and the combination at nodes 304-2 and 304-3 are not searched.

This pruning occurs because any combination that includes the name-value pairs 306 of the pruned node 304-1 would necessarily return a measurement of an even smaller subset of alerts, making it unnecessary to analyze these combinations further. This pruning mechanism substantially reduces the number of combinations that need to be evaluated, thereby improving the overall performance of the analysis. The tree structure also allows for efficient tracking of the relationships between different name-value pair combinations. Additionally, as more name-value pairs are added to the combinations and the number of matching alerts decreases, the system needs to scan fewer and fewer alerts to determine if they match the name-value pairs that are being added.

By leveraging this tree structure with its pruning capability, embodiments of disclosure can efficiently process large volumes of alert data, identify significant groups, and provide meaningful insights to security analysts. This approach addresses the challenges of alert fatigue and noise in SIEM (and other security) systems by offering a systematic and computationally efficient method for refining alert rules and reducing false positives.

Therefore, the combinations considered for the search may be defined by tree structure 300 having root 302, branches 310 and nodes 304. The combinations associated with the nodes 304 further away from the root 302 of the tree structure 300 include a corresponding increasing number of the name-value pairs 306. For a given node 304, the combination of the name-value pairs 306 of that node 304 is included in the combinations of all sub-nodes of that node 304.

The processor 28 is configured, in response to searching for a given combination of name-value pairs 306 (associated with a node 304 in tree structure 300) in the alerts 46 returning a measurement of alerts 46 below a threshold, to prune a part of the tree 300 to remove all of the branches 310 below that node so that combinations of the name-value pairs 306 associated with the pruned part of the tree 300 are omitted from future searching.

The tree structure 300 is used to provide a structure for searching. The root 302 is searched first, typically as part of the preparatory steps to determine whether to remove name-value pairs included in less than the threshold (e.g., 30%) of the alerts or included in 100% of the alerts, as described in more detail with reference to the step of block 216 above, with reference to FIG. 2. Then the combinations in each level of the tree structure 300 are used in the search so that the combinations of name-value pairs associated with nodes 304 in the second level of tree structure 300 are used in the searches, then the combinations of name-value pairs associated with nodes 304 in the third level of tree structure 300 are used in the searches, and so on. When the search with a combination of name-value pairs associated with a node yields a measurement of the alerts less than the threshold, the tree structure 300 is pruned at that node and all sub-nodes of that node are removed from the tree structure 300 for searching purposes. As previously mentioned, the tree structure 300 is repeated with each name-value pair being disposed in the root 302, and the search using the combinations is repeated for each such tree structure 300. For example, a new tree structure is generated with F2:V1 at the root 302 and another new tree structure is generated with F2:V2 at the root 302, and so on.

Reference is now made to FIG. 4, which is a flowchart 400 including steps in a searching sub-method of the method of FIG. 2. The steps described with respect to FIG. 4 may be applied with or without use of tree structures 300 to aid the searching alerts for the combinations of the name-value pairs. The processor 28 is configured to start searching with the combinations of two name-value pairs (block 402). The processor 28 is configured to select a new combination of name-value pairs from the available name-value pairs (block 404), e.g., from tree structures 300. The new combination of name-value pairs may be selected using any suitable algorithm, for example by examining how many alerts a name-value pair matches individually (and selecting the name-value pairs with the highest number of matches individually), or by examining how many different values a field has in all of the alerts, or by selecting new name-value pairs from an ordered list of fields that should be checked first (e.g., IP, hostname, user; as opposed to more esoteric field names). The processor 28 is configured to search for the selected name-value pairs (selected in the step of block 404) in the alert data 46 (block 406) and calculate a measurement (e.g., count, percentage, or fraction) of the alerts 46 in which the selected name-value pairs are included (block 408). At a decision block 410, the processor 28 is configured to check whether the measurement is below a threshold (e.g., 30%). If the processor 28 finds that the search for the selected combination of name-value pairs returns a measurement of alerts below the threshold measurement, the processor 28 is configured to omit from future searching any other combinations of name-value pairs that include the select combination of name-value pairs (block 412) and then continue the method with decision block 414. The step of block 412 may include pruning tree structure 300 at the node 304 of the selected combination. It should be noted that different trees 300 (or even the same tree 300) may include the same combination of name-value pairs, and the processor 28 may be configured to prune any relevant nodes 304 of any relevant tree structure 300 in response to finds that the search of a selected combination of name-value pairs returns a measurement of alerts below the threshold measurement.

If the processor 28 does not find that the search for the selected combination of name-value pairs returns a measurement of alerts below the threshold measurement, the method continues with the step of decision block 414.

At decision block 414, the processor 28 checks to determine if there are any more combinations with the same number of name-value pairs as the current combination (e.g., using the tree structures 300). If there are more combinations with the same number of name-value pairs as the current combination, the method continues with the step of block 404, where the processor 28 is configured to select a new combination of name-value pairs (e.g., from the tree structures 300), and continue the method with steps 406, 408 etc. If there are no more combinations with the same number of name-value pairs as the current combination, the processor 28 is configured to increase the number of name-value pairs in the combinations (by 1) and continue with the step of block 404, where the processor 28 is configured to select a new combination with the increased number of name-value pairs (e.g., from the tree structures 300), and continue the method with steps 406, 408 etc.

In the above description, the tree structure 300 is traversed one level at a time so that once level 1 has been exhausted, level 2 is explored, and so on. In other embodiments, the tree structure 300 may be explored one branch at a time, exploring all the possible sub-branches of a branch by adding more name-value pairs to each combination until that branch or sub-branch is pruned or until there are no more name-value pairs to add. Then, another branch is explored, and so on.

The step of block 416 is typically performed multiple times and includes the processor 28 being configured to progressively increase the number of the name-value pairs in the combinations according to an increasing number of the name-value pairs. The processor 28 is configured to search for the combinations of the name-value pairs and iteratively increase the number of the name-value pairs in the combinations until a stopping condition is met (e.g., there are no more remaining name-value pairs with which to perform searching for new combinations in the alerts).

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A method for improving protection of a computer system from malicious activity, comprising:
receiving a set of alerts generated by a rule of a security monitoring system over a specified time period;
analyzing the alerts to identify groups of name-value pair combinations, the analyzing including:
searching for combinations of name-value pairs within the set of alerts; and
calculating a measurement of alerts for each of the combinations; and
presenting one or more what-if scenarios to a user, each scenario showing an impact of the identified groups of name-value pair combinations in the security monitoring system.

2. The method according to claim 1, wherein each of the alerts includes an array of elements having corresponding field names and values, such that each field and associated value or part of the associated value defines a corresponding name-value pair.

3. The method according to claim 1, wherein:
the analyzing includes analyzing the alerts to identify potential exclusions of the rule;
the calculating including calculating the measurement of alerts that would be excluded by each of the combinations; and
the presenting includes presenting the one or more what-if scenarios to the user, each scenario showing the impact of applying a potential exclusion to the rule in the security monitoring system.

4. The method according to claim 1, wherein the analyzing the alerts comprises:
finding a given combination that returns the measurement of the alerts below a first threshold measurement; and
omitting from the searching any other ones of the combinations that include the given combination.

5. The method according to claim 4, wherein the searching for the combinations comprises:
starting with the combinations of two name-value pairs; and
progressively increasing the number of the name-value pairs in the combinations.

6. The method according to claim 5, wherein:
the combinations considered for the searching are defined by a tree structure having a root, branches and nodes;
the combinations associated with the nodes further away from the root of the tree structure include a corresponding increasing number of the name-value pairs;
for a given one of the nodes, the combination of the name-value pairs of the given node is included in the combinations of all sub-nodes of the given node; and
the method further comprises, in response to the searching for the given combination of the name-value pairs in the alerts returning the measurement of the alerts below the first threshold, pruning a part of the tree to remove all of the branches below a corresponding one of the nodes so that combinations of the name-value pairs associated with the pruned part of the tree are omitted from the searching for the combinations.

7. The method according to claim 5, wherein the searching for the combinations of the name-value pairs comprises iteratively increasing the number of the name-value pairs in the combinations until a stopping condition is met.

8. The method according to claim 4, further comprising, prior to the searching for the combinations of the name-value pairs:
removing the name-value pairs present in less than a second threshold measurement of the alerts or equal to 100% of the alerts;
merging the name-value pairs that always appear together in the alerts into a merged name-value pair; and
removing one or more generic or derived name-value pairs, wherein the removed name-value pairs are not used in the searching for the combinations, and the merged name-value pair is used in the searching for the combinations.

9. The method according to claim 4, further comprising, prior to the searching for the combinations of the name-value pairs:
removing the name-value pairs present in less than a second threshold measurement of the alerts or equal to 100% of the alerts, wherein the removed name-value pairs are not used in the searching for the combinations; and
adding back to at least one of the combinations of the name-value pairs, the previously removed name-value pairs equal to 100% of the alerts.

10. The method according to claim 4, further comprising, prior to the searching for the combinations of the name-value pairs, removing one or more generic or derived name-value pairs, wherein the removed one or more generic or derived name-value pairs are not used in the searching for the combinations.

11. The method according to claim 4, further comprising, prior to the searching for the combinations of the name-value pairs, merging the name-value pairs that always appear together in the alerts into a merged name-value pair, wherein the merged field name-value pair is used in the searching for the combinations.

12. The method according to claim 1, further comprising applying a selected exclusion to update the rule or replace the rule based on user input of one of the what-if scenarios.

13. The method according to claim 1, further comprising downloading the set of alerts via an application programming interface (API) of the security monitoring system.

14. The method according to claim 1, wherein the presenting the one or more what-if scenarios comprises:
displaying the combinations having the measurement of the alerts greater than a given threshold measurement; and
sorting the displayed combinations by the measurement of the alerts for the respective combinations.

15. The method according to claim 1, wherein the measurement of alerts is a percentage of alerts.

16. A system for improving protection of a computer system from malicious activity, comprising:
a processor configured to:
receive a set of alerts generated by a rule of a security monitoring system over a specified time period;
analyze the alerts to identify groups of name-value pair combinations;
search for combinations of name-value pairs within the set of alerts;
calculate a measurement of alerts for each of the combinations; and
present one or more what-if scenarios to a user, each scenario showing an impact of the identified groups of name-value pair combinations in the security monitoring system; and
a memory to store data used by the processor.

17. The system according to claim 16, wherein the processor is configured to:
analyze the alerts to identify potential exclusions of the rule; and
calculate the measurement of alerts that would be excluded by each of the combinations, wherein each what-if scenario shows the impact of applying a potential exclusion to the rule in the security monitoring system.

18. The system according to claim 16, wherein the processor is configured to:
find a given combination that returns the measurement of the alerts below a first threshold measurement; and
omit from searching any other ones of the combinations that include the given combination.

19. The system according to claim 18, wherein the processor is configured to:
start searching for the combinations with the combinations of two name-value pairs; and
progressively increase the number of the name-value pairs in the combinations used in the searching.

20. The system according to claim 19, wherein:
the combinations considered for the searching are defined by a tree structure having a root, branches and nodes;
the combinations associated with the nodes further away from the root of the tree structure include a corresponding increasing number of the name-value pairs;
for a given one of the nodes, the combination of the name-value pairs of the given node is included in the combinations of all sub-nodes of the given node; and
the processor is configured, in response to the searching for the given combination of the name-value pairs in the alerts returning the measurement of the alerts below the first threshold, to prune a part of the tree to remove all of the branches below a corresponding one of the nodes so that combinations of the name-value pairs associated with the pruned part of the tree are omitted from the searching for the combinations.

21. The system according to claim 19, wherein the processor is configured, prior to the searching for the combinations of the field values of the different fields, to:
remove the name-value pairs present in less than a second threshold measurement of the alerts or equal to 100% of the alerts;
merge the name-value pairs that always appear together in the alerts; and
remove one or more generic or derived name-value pairs, wherein the removed name-value pairs are not used in the searching for the combinations, and the merged name-value pairs are used in the searching for the combinations as a merged name-value pair.

22. The system according to claim 16, wherein the processor is configured to apply a selected exclusion to update the rule or replace the rule based on user input of one of the what-if scenarios.

23. A non-transitory computer-readable storage medium storing instructions that, when executed by a processor, cause the processor to:
receive a set of alerts generated by a rule of a security monitoring system over a specified time period;
analyze the alerts to identify groups of name-value pair combinations:
search for combinations of name-value pairs within the set of alerts; and
calculate a measurement of alerts for each of the combinations; and
present one or more what-if scenarios to a user, each scenario showing an impact of the identified groups of name-value pair combinations in the security monitoring system.
